(19) United States
(12) Patent Application Publication
(10) Pub. No.: US 2012/0011690 A1
(43) Pub. Date: Jan. 19, 2012

(54) REMOVABLE FIXTURE FOR MANUFACTURING DEVICE

(75) Inventors: Daniel Karraker, Cupertino, CA (US); Thomas Johannessen, Fjerdingby (NO); Xiao Bing Cai, Jiangsu (CN)

(73) Assignee: APPLE INC., Cupertino, CA (US)

(21) Appl. No.: 13/139,269

(22) PCT Filed: May 18, 2010
(86) PCT No.: PCT/CN10/00700

§ 371 Date: Jun. 10, 2011

(51) Int. Cl. B23P 19/04; B23P 19/00

(52) U.S. Cl. 29/248; 29/700

(57) ABSTRACT

A CNC system can include a cylinder adapted to rotate about, travel along, and deliver a force in an axial direction, an extension coupled to a distal end of and extending outward from the elongated component in a direction perpendicular to the axial direction, and a removable fixture adapted to receive the axial force and to be moved and positioned thereby along a plane (i.e., two directions) substantially perpendicular to the axial direction. The fixture has a central opening along the first direction adapted to receive the elongated component, and includes external features adapted to guide manufacturing operations for other manufacturing components. Chamfers on both the extension and removable fixture convert the downward axial force into a plurality of lateral forces that move the fixture against a receiver base. Datums located at guide holes in the fixture stop such lateral movement when the movement causes them to contact guide pins coupled to the receiver base.

### TECHNICAL FIELD

The present invention relates generally to manufacturing devices and processes, and more particularly to devices and methods for accurately locating removable fixtures in a manufacturing system.

### BACKGROUND

Computer numerical control (“CNC”) machines are ubiquitous in many manufacturing plants and environments, and can include machinery involving drilling, cutting, lathing, routing, grinding and other component manufacturing and handling processes. One or more fixtures or other handling components are often important features in many CNC machines. Such fixtures generally allow for the repeatable, accurate and firm placement of work pieces or parts as such items are processed or transferred from one machine to another. Erowa AG of Buron, Switzerland is one company that makes a variety of CNC machines and components, and various examples of CNC machines, fixtures and other components can be found, for example, on the Erowa web site at www.erowa.com.

In many instances, CNC fixtures are customized for a particular application. CNC fixtures are sometimes formed in a manner that is permanent and inflexible, which can result in fixtures and surrounding components that become obsolete and useless whenever relevant parts or items are sufficiently revised or fall out of demand. Because of this, it is often desirable to develop as many CNC system fixtures and other components in a manner that permits as much interchangeability as possible when part specifications or component demands change. For example, an ordinary table or base component for a given manufacturing process typically does not need to be changed or replaced when there are substantial changes to a part or work piece that is processed at that base component.

On the other hand, the fixture or fixtures that handle and accurately place a given part or work piece for a given manufacturing operation will often need to be modified or replaced whenever there are any significant changes or replacements of such a part or work piece. This can often result in the modification or replacement of one or more items used to support a fixture as well, since CNC fixtures are oftentimes permanently installed or attached somewhere. Such permanent installation is often due to the need for speed and reliably high precision in locating processed parts or work pieces, since removable or temporary CNC fixture installations are often less reliable than those that are permanent.

In addition, a failure or defect at any particular location on a CNC fixture can result in a significant loss of manufacturing time while the fixture is repaired on site or while the fixture and any attached supporting structures are removed and relocated for repairs. Of course, such manufacturing down time results in delays and undesirable costs to an overall manufacturing operation. Furthermore, any replacement of supporting structures when a full fixture replacement is necessary also results in significant added costs.

While many designs and techniques used With respect to CNC fixtures have generally worked well in the past, there is always a desire to provide further designs and techniques for fixtures that are more flexible and cost effective. In particular, what are desired are improved CNC fixtures that are more readily removable and interchangeable, without sacrificing high speed or precise placement with respect to the parts or work pieces processed thereby.

### SUMMARY

It is an advantage of the present invention to provide CNC systems having fixtures that are readily removable yet still permit precise placement with respect to the various parts or work pieces processed thereby. This can be accomplished at least in part through the use of a removable fixture adapted to receive an incumbent clamping force and convert it into lateral motion of the fixture that is stopped by multiple accurately located datums.

In various embodiments of the present invention, a component manufacturing system can include an elongated component having a longitudinal axis therethrough defining a first direction, an extension coupled to the elongated component and extending outward therefrom in a second direction having a component that is perpendicular to the first direction, and a removable fixture adapted to receive the force delivered thereto by said extension. The elongated component can be adapted both to rotate about and travel along the first direction, and also to deliver a force along the first direction. The extension can operate to convert the force from the first direction to second and third directions having components that are perpendicular to each other and the first direction. The removable fixture can have an inner opening extending therethrough along the first direction adapted to receive and permit movement by the elongated component, and the removable fixture can be moved and positioned in both of the second and third directions as a result of the force. Of course, the removable fixture can be adapted to guide manufacturing operations for other manufacturing components or parts.

In various detailed embodiments, the elongated component can be cylindrical, and can be powered or driven by pneumatic pressure. In various embodiments, the extension is removably coupled to a distal end of the elongated component. In some embodiments, the removable fixture can be readily removed from the system without removing the extension from the elongated member. In addition, the removable fixture can include a top plate and a bottom plate that are mounted with respect to each other.

Further items in the component manufacturing system can include a receiver base adapted to support the removable fixture, wherein the removable fixture is positioned accurately with respect to the receiver base in both of the second and third directions as a result of said force. In some embodiments, the removable fixture can be positioned in both second and third directions within a tolerance of one micron. In some embodiments, the removable fixture includes a plurality of guide holes therein, and the receiver base includes a plurality of guide pins that are positioned such that the removable fixture is mountable to the receiver base by matching the guide pins with the guide holes. In some detailed embodiments, one or more of said plurality of guide pins define a cross-section that is generally cylindrical with the exception of at least one flat side.

Still further items in the component manufacturing system can include a plurality of datums located in the plurality of guide holes, with such datums operating to position the removable fixture accurately in both of the second and third directions as a result of the force. The plurality of datums can operate to position the removable fixture by contacting the plurality of guide pins such that motion of the removable fixture in both of the second and third directions is stopped when the datums are contacted by the guide pins. In addition, a plurality of chamfered regions can be located on both the extension and the removable fixture, and adapted to engage each other when the extension moves in the first direction against the removable fixture. In such an arrangement, the engaging chamfer regions operate to convert the force from the first direction to the second and third directions thereby.

In various embodiments of the present invention, a removable CNC fixture can include one or more external surface regions adapted to facilitate the handling of manufacturing parts or work pieces, a central opening extending therethrough, and adapted to receive and permit axial and rotational movement therethrough by a separate elongated component having a primary axis and a separate extension coupled thereto, a plurality of chamfered regions adapted to engage with a plurality of chamfered regions on the extension, a plurality of guide holes adapted to mount to a plurality of guide pins therethrough from a separate receiver base, and a plurality of datums located within said plurality of guide holes. Similar to the foregoing system embodiment, an incumbent force from the separate extension causes engagement of the plurality of chamfered regions on the extension onto the plurality of chamfered regions on the removable CNC fixture and results in the movement of the removable CNC fixture in a plane that is substantially perpendicular to the primary axis of the separate elongated component. The plurality of datums can operate to position the removable fixture accurately in said plane as a result of the incumbent force from the separate extension.

In various detailed embodiments With respect to either of the system or CNC fixture above, the plurality of fixture chamfered regions comprise two orthogonally adjacent chamfers. In various embodiments, the extension can be removably coupled to a distal end of the elongated component. Where such a removable attachment exists, removal of said extension can permit an easier removal of the removable fixture from the respective system. In other embodiments, the extension can be integrally formed With the elongated component. Whether the elongated component and extension are integrally formed or made from multiple items, the removable fixture can be readily removed from the system without needing to separate the extension from the elongated member in some embodiments. Such an arrangement can include a rotational action of the elongated member and extension, wherein a first rotational position permits the ready installation and removal of the removable fixture, and a second rotational position facilitates the clamping of the extension and exertion of force against the removable fixture.

In various further embodiments, methods of handling manufacturing items in a CNC system are provided. Pertinent method steps can include mounting a removable CNC fixture to a respective receiver base, extending an elongated component having a primary axis through a central opening of the fixture, coupling an extension to a distal end of the elongated component while the elongated component is extended through the central opening, rotating the elongated component about its primary axis such that the position of the extension is altered, moving the elongated component along the primary axis so that the extension contacts and exerts a downward force against the fixture, translating the downward force against the fixture into one or more resultant forces having a direction substantially perpendicular to the downward force such that the fixture moves laterally with respect to the receiver base, stopping the lateral movement of the removable CNC fixture as a result of a plurality of datums, and handling one or more manufacturing items against one or more external surface features of the removable CNC fixture after said stopping step. The mounting step can involve the use of a plurality of guide pins on the receiver base and a plurality of corresponding guide holes in the removable CNC fixture, and the central opening can be adapted to facilitate the axial and rotational movement of the elongated component. In addition, the datums can be carefully located within the guide holes contacting the guide pins, such that the stopping results in a desired accurate positioning of the removable CNC fixture. An additional step can include removing the removable CNC fixture from the CNC system.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the disclosed inventive apparatuses and methods for accurately locating a removable fixture on or with respect to a manufacturing device or tool. These drawings in no way limit any changes in form and detail that may be made to the invention by one skilled in the art without departing from the spirit and scope of the invention.

FIG. 1A illustrates in front perspective view an exemplary CNC component manufacturing system having a clamped removable fixture according to one embodiment of the present invention.

FIG. 1B in front perspective view the exemplary CNC component manufacturing system of FIG. 1A with an undamped removable fixture and raised clamping arrangement according to one embodiment of the present invention.

FIG. 2 illustrates in top plan view the exemplary CNC component manufacturing system of FIG. 1A with its removable fixture clamped according to one embodiment of the present invention.

FIG. 3 illustrates in front perspective exploded view an alternative exemplary component manufacturing system according to one embodiment of the present invention.

FIG. 4A illustrates in top plan view the exemplary assembled removable fixture shown in FIG. 3 according to one embodiment of the present invention.

FIG. 4B illustrates in bottom obverse view the exemplary assembled removable fixture shown in FIG. 3 according to one embodiment of the present invention.

FIG. 5A illustrates in top plan view another alternative exemplary component manufacturing system according to one embodiment of the present invention.

FIG. 5B illustrates in side cross-sectional view the exemplary component manufacturing system as a clamping force is applied according to one embodiment of the present invention.

FIG. 6A illustrates in bottom obverse view the exemplary extension shown in FIGS. 5A and 5B according to one embodiment of the present invention.

FIG. 6B illustrates in top plan view the exemplary recessed area of the removable fixture shown in FIGS. 5A and 5B according to one embodiment of the present invention.

FIG. 7 provides a flowchart of an exemplary method of handing manufacturing items in a CNC system according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

The present invention generally relates in various embodiments to a CNC manufacturing system having a removable and interchangeable fixture. Such fixtures can be readily and quickly installed into the system and still allow for precise positioning of the fixture such that handled work pieces or parts can be precisely located as well during manufacturing. Although the following specific embodiments have been described with respect to a horizontally arranged removable fixture and a vertically clamping cylinder and extension head, it will be readily appreciated that any directional arrangement of components can be used without departing from the inventive features described herein and claimed below. For example, the removable fixture can be arranged vertically, or at an angle between horizontal or vertical. Alternatively, the removable fixture can be arranged in an upside down position with respect to the exemplary illustrations shown. Further alternative embodiments will be readily appreciated by those skilled in the art.

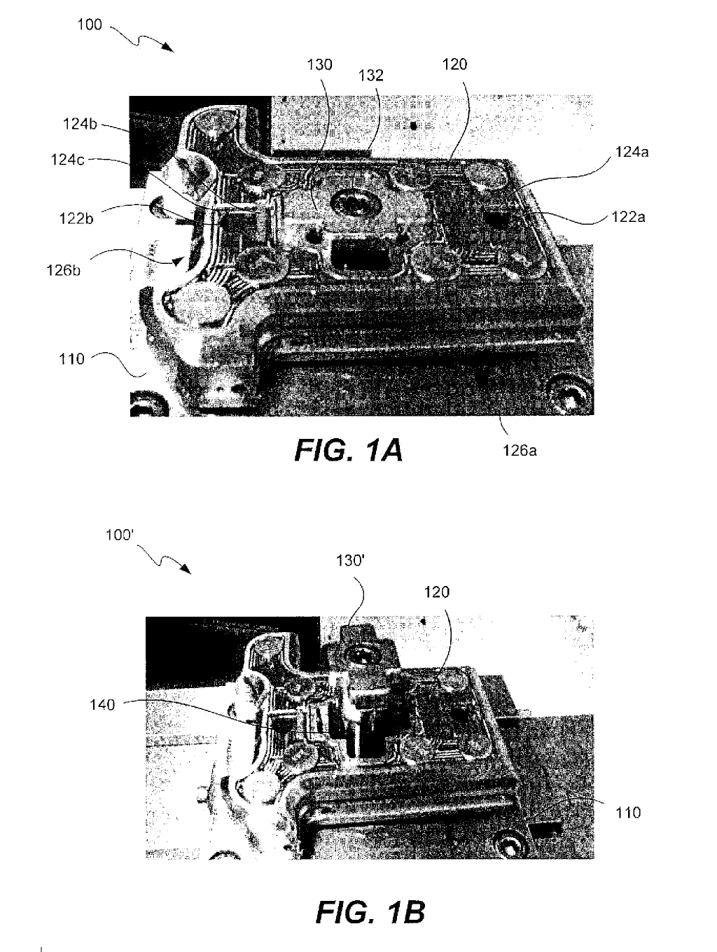

Referring first to FIGS. 1A and 1B, an exemplary CNC component manufacturing system is shown in similar front perspective views with its removable fixture being clamped and unclamped according to one embodiment of the present invention. Component manufacturing system 100 can include a receiver base 110 adapted to support a removable fixture 120. An extension head or extension 130 having a hex screw 132 or other suitable coupler can be T-shaped, for example, and can be coupled to a distal end of a cylinder or other elongated member 140. This extension is shown in its clamped position 130 in clamped system 100 in FIG. 1A, and in its raised and rotated (i.e., undamped) position 130′ in unclamped system 100′ in FIG. 1B. Various features on removable fixture 120 include a plurality of guide holes 122a, 122b, a plurality of datums 124a, 124b, 124c located within the guide holes and a plurality of external surface regions 126a, 126b adapted to facilitate the handling of manufacturing parts or work pieces (not shown).

Elongated member 140 can generally define a longitudinal axis (e.g., vertical or z-axis) therethrough about which the cylinder or member rotates and along which it travels. Elongated member, which will be understood to have potential shapes and cross-sections other than a cylinder, can be pneumatically powered, although hydraulic or other types of power may also be used as desired. In general, elongated member moves and rotates between two different positions, which results in the clamped position 130 and the unclamped position 130′ of extension 130. Although the amount of rotation is shown as being about 90 degrees, it will be readily appreciated that other rotations may also be used, such as, for example, 45 degrees.

As will be readily appreciated, removable fixture 120 is loose and can be moved around significantly in the horizontal plane perpendicular to the longitudinal axis of the elongated member 140 (i.e., in both x and y directions) with respect to receiver base 110 when extension 130′ is in its unclamped position. When the elongated member 140 moves downward in the z-direction, however, then the extension 130 can rotate and exert a downward force onto the receiving surfaces of the removable fixture 120. This downward force is then converted into one or two horizontal force components, which can operate to move the removable fixture accurately into a desired position with respect to receiver base 110. Of course, the removable fixture 120 is not moved in the event that it is already in its proper position on the receiver base 110. The mechanics of this movement and accurate placement of fixture 120 are set forth in greater detail below.

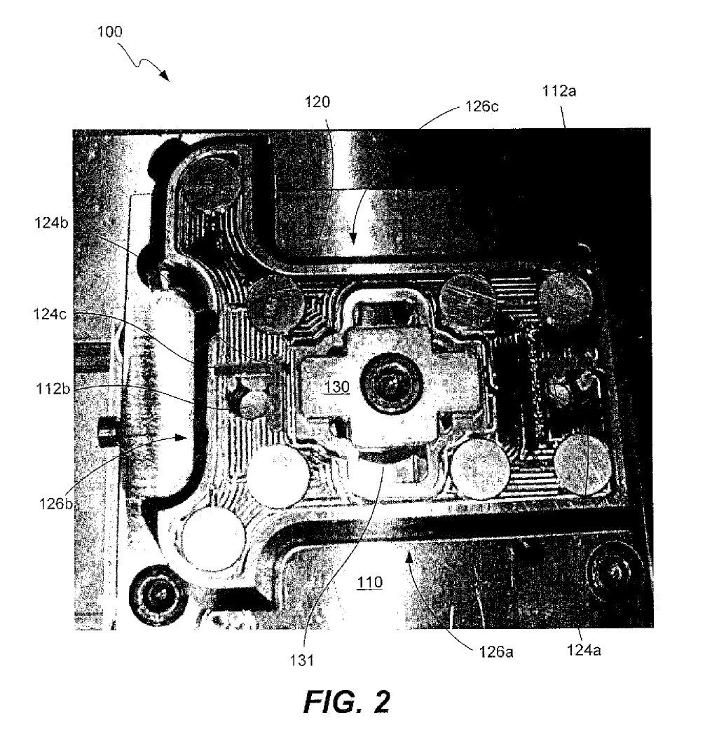

FIG. 2 illustrates in top plan view the exemplary the exemplary CNC component manufacturing system of FIG. 1A with its removable fixture clamped according to one embodiment of the present invention. FIG. 2 effectively provides different view of the same system 100 shown in FIG. 1A. The receiver base 110, removable fixture 120, extension 130 and external surface regions 126a, 126b, 126c are all in the same locations and positions as shown in FIG. 1A. In addition, guide pins 112a, 112b can be seen within the guide holes of removable fixture 120. These guide pins 112a, 112b can be affixed or coupled to receiver base 110, such that the removable fixture 120 is mounted onto the receiver base by way of the guide pins being inserted into the guide pin holes. The guide pins can be somewhat smaller than the guide holes, such that mounting can be readily and quickly accomplished, although this also results in a significant amount of play or “slop” between the guide pins and guide holes. That is to say, removable fixture 120 can be moved a significant amount in both the x and y directions when it is mounted to the receiver base 110 by way of multiple guide pins 112x being inserted into respective guide holes 122x.

In order for removable fixture 120 to be accurately positioned as a result of the downward incumbent force delivered upon it by the extension 130, a plurality of carefully placed datums 124a, 124b, 124c can be implemented. These datums effectively stop the lateral movement of the removable fixture in respective x and y directions, and thereby serve to accurately position the removable fixture, as the downward incumbent force delivered to the fixture will force the fixture to move until it is stopped by the guide pins contacting the datums. Accordingly, the guide pins, datums and supporting components thereto must be appropriately designed to withstand the force delivered by the extension. As shown, datums 124a and 124c serve to stop movement of removable fixture 120 in the y direction, while datum 124b serves to stop movement in the x direction. Accordingly, accurate placement of the datums on the removable fixture is important. As such, the datums can be located and refined precisely to reflect where the locations of the various external surface regions 126a, 126b, 126c should be. Such datum placement can include, for example, any treatment or machining of datums once they are located within guide holes. Also, guide pins may be flat on surfaces that are to contact datums, for greater reliability.

Although only one datum is ultimately necessary to stop movement in a given direction, it may be preferable to include at least two datums for each direction, so as to limit undesired torquing, for example. In the even that one datum per direction is used, then locating such a datum directly in line with extension 130 is preferable. Also, although system 100 is shown as having two guide pins 112a, 112b and two guide holes 122a, 122b, it will be readily appreciated that more guide pins and corresponding guide holes may also be effectively used. In fact, three or four guide-pins and holes are also thought to work well.

FIG. 2 can also be used to appreciate another pertinent feature of component manufacturing system 100. As noted above, cylinder or elongated member 140 rotates such that extension 130 can be rotated between “clamped” 130 and unclamped 130′ positions. In some embodiments, uncia.mped position 130′ can also be considered an “open” position, such that the extension can slide through opening 131 in the removable fixture 120 and the entire removable fixture can be readily removed from system 100. Such a ready removal can be accomplished due to the nature of the shapes of extension 130 and opening 131. As shown, extension can be generally shaped in the form of a T or cross, with one set of extension arms being relatively long and narrow, and another set of extension arms being relatively short and wide. Thus, in the “clamped position, the ends of the long arms cannot fit through the shorter portions of opening 131, while the width of the short, arms cannot fit through the narrower portions of opening 131. Of course, other shapes can be used in a similar manner to achieve the same general results, as may be desired.

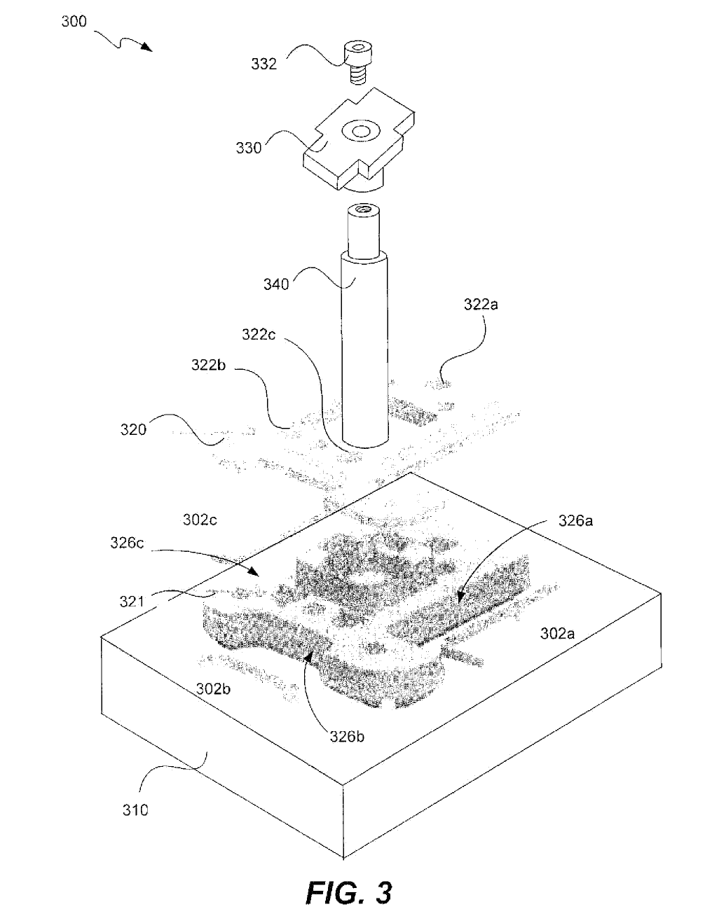

Turning now to FIG. 3, an alternative exemplary component manufacturing system according to one embodiment of the present invention is illustrated in front perspective exploded view. Component manufacturing system 300 can be substantially similar to the system 100 provided above. In particular, system 300 can include a receiver base 310 adapted to support a removable fixture 320/321, as well as an extension 330 having a hex screw 332 or other suitable coupler that is coupled to a distal end of a cylinder or other elongated member 340. One significant difference is that system 300 includes three guide pins (not shown) and three guide holes 322a, 322b, 322c, with each guide hole having respective datums therein. Also, the removable fixture can be split into a top plate 320 and bottom plate 321, which can be separable but clamped together when intended for use. Such an arrangement can allow for easier and more accurate installment of the various datums in a bottom plate 321, for example.

One or more external parts or work pieces 302a, 302b, 302c can be handled at various external locations 326a, 326b, 326c on the removable fixture, as shown. Again, installment of the various datums can be made in a manner such that a precise arrangement and location of the external locations 326a, 326b, 326c can he readily achieved during clamping of the removable fixture 320/321. As will be readily appreciated, removal of the hex screw 332 or other distal end coupling component can facilitate an even easier removal of extension head 330, which then allows the entire removable fixture 320/321 to be removed off of base 310 and cylinder 340 to be taken away from the system 300 for repair or replacement. Similar to system 100 above, however, it may be preferable for the entire removable fixture 320/321 to be removable from the system 300 when cylinder 340 and extension 330 are rotated to an unclamped or open position, even without removing the extension.

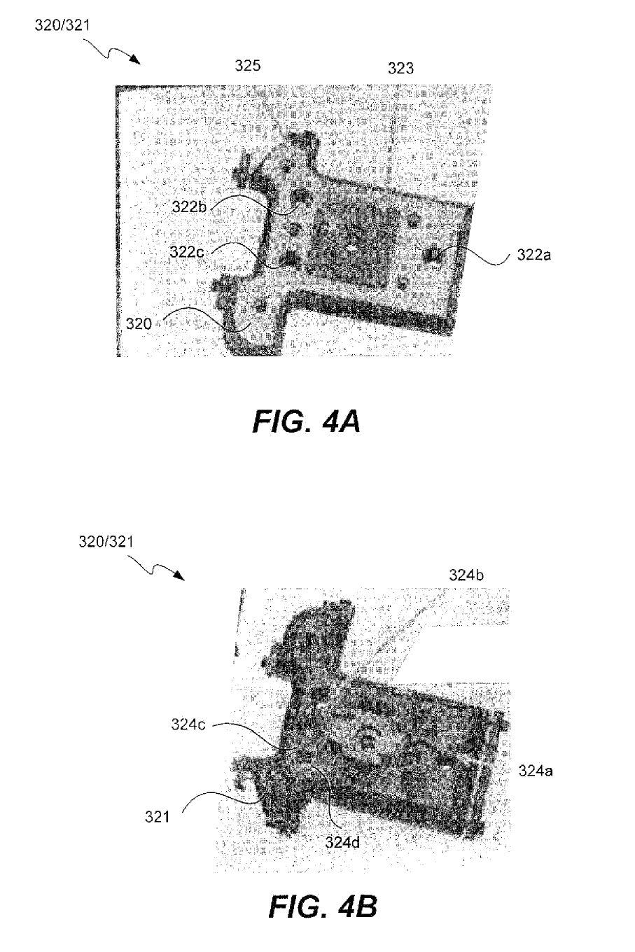

Continuing with FIGS. 4A and 4B, the assembled removable fixture of FIG. 3 is shown in top plan and bottom obverse views respectively. Again, assembled removable fixture 320/321 includes top plate 320 and bottom plate 321 being clamped or otherwise coupled together. Guide holes 322a, 322b, 322c can exist in both the top plate and bottom plate, and are adapted to accommodate corresponding guide pins (not shown) from the receiver base. Top plate 320 can have a substantial center opening that allows a raised portion 323 of bottom plate 321 to protrude therethrough. This raised portion can include a recessed area 325 that contains a plurality of chamfers adapted to interact with chamfers on the extension (not shown), which operate to convert the downward vertical force into horizontal force(s).

A plurality of datums 324a, 324b, 324c, 324d can be located within the guide holes, particularly on bottom plate 321. As shown, datums 324a and 324c can operate to stop movement of the removable fixture 320/321 in the y direction, while datums 324b and 324d operate to stop movement of the removable fixture 320/321 in the x direction. For purposes of efficiency, two datums for different directions can be placed in a single guide hole, such as the case of datums 324c and 324d.

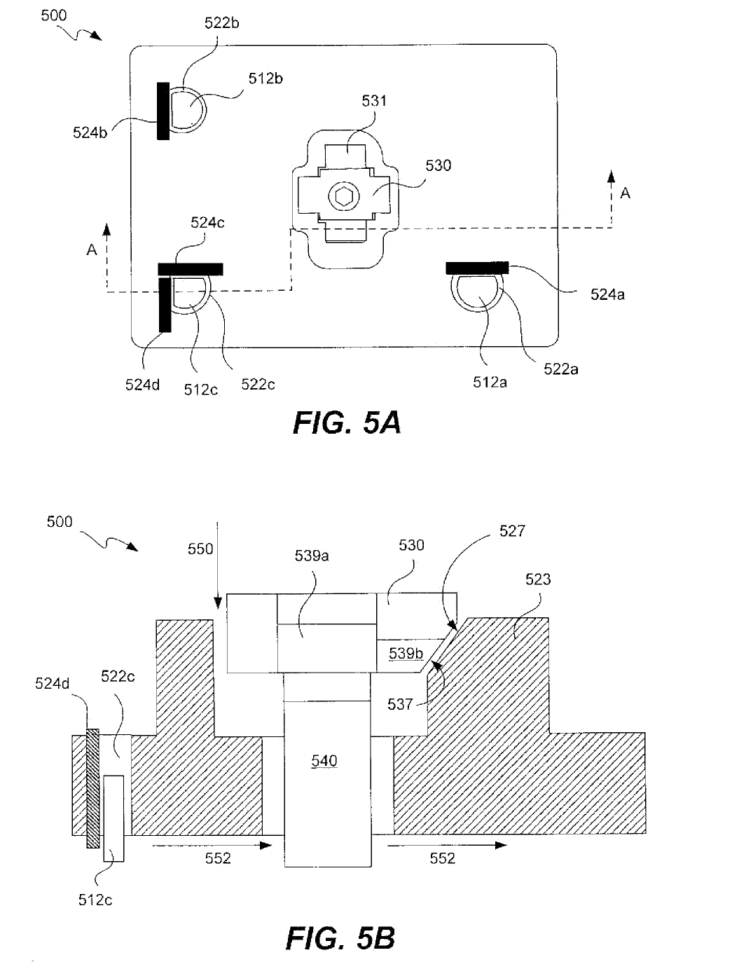

Moving next to FIG. 5A, another alternative exemplary component manufacturing system according to one embodiment of the present invention is illustrated in top plan view. Component manufacturing system 500 can be substantially similar to system 300 provided above, and can have a layout that includes a centrally located extension 530, such as through a central opening in a removable fixture. A plurality of guide pind 512a, 512b, 512c can be located within a plurality of guide holes 522a, 522b, 522c respectively, and a plurality of datums 524a, 524b, 524c, 524d can be located within the guide holes as shown. Functionalities of these various components can be identical or substantially similar to the foregoing described systems.

FIG. 5B illustrates in side cross-sectional view along line A-A from FIG. 5A the component manufacturing system 500 as a clamping force 550 is applied downward from extension 530 onto a raised portion 523 of the removable fixture. As noted above, extension 530 can be coupled to and driven by a cylinder or other elongated member 540. As extension 530 contacts the raised portion 523 of the fixture, actual contact is made between a chamfered region 537 of the extension and a chamfered region 527 of the removable fixture. This interaction converts the downward force 550 into a horizontal or lateral force 552. The chamfered regions 527, 537 slide with respect to each other, and the entire fixture is moved in the direction of the lateral force 552. As shown with respect to FIG. 5A, this is in the x-direction for purposes of this embodiment.

This lateral movement of the removable fixture is stopped when the guide pin 512c located in guide hole 522c contacts datum 524d. A similar contact occurs with respect to guide pin 512b and datum 524b, as will be readily appreciated. As will also be appreciated, a similar interaction can occur between chamfered regions 539a and 539b of extension 530 and corresponding chamfered regions (not shown) of the removable fixture. This interaction results in a y-direction lateral movement, which is stopped by pins 512a and 512c contacting datums 524a and 524e respectively. Of course, the exact geometry of the interacting chamfered regions on both the extension 530 and raised portion 523 of the removable fixture should be manipulated such that suitable forces can be converted in two lateral directions When a clamping force is applied, and also so that the removable fixture can be readily removed from the system when the cylinder and extension are rotated to an open position, as noted above.

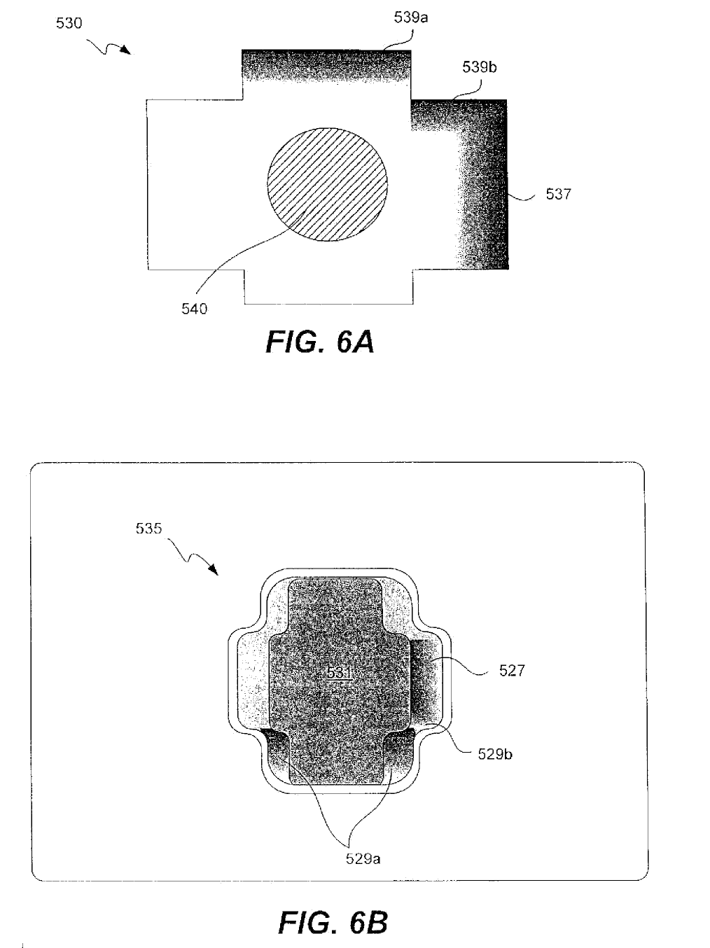

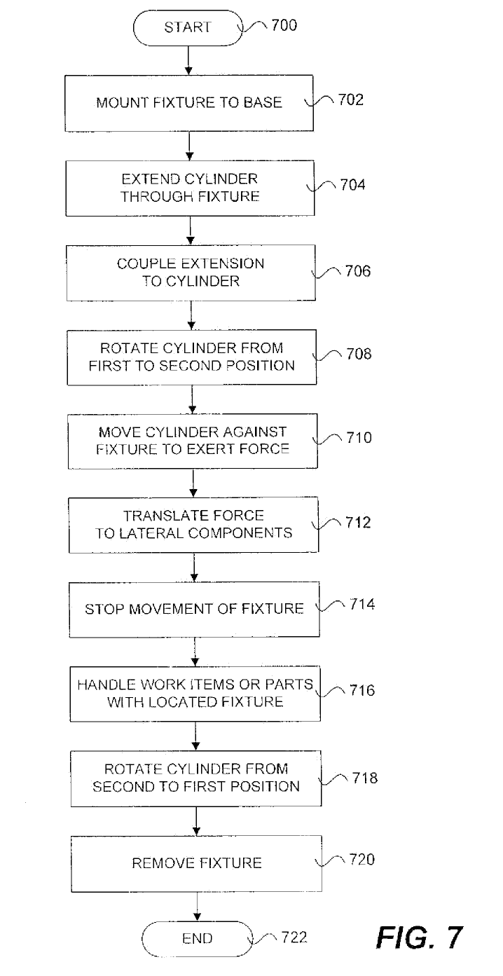

Continuing now with FIG. 6A, the exemplary extension shown in FIGS. 5A and 5B is depicted in bottom obverse view. Extension 530, which can be T-shaped, X-shaped, or can have a wide variety of alternative shapes, can have one chamfered region 537 to convert force into a first lateral direction and one or more other chamfered regions 539a, 539b to convert force into a second lateral direction. Each chamfered region operates to convert vertical force delivered by coupled cylinder 540 from the extension 530 into lateral force and subsequent movement on an associated removable fixture. A wide variety of profiles and angles for chamfered region may be suitable, as will be readily appreciated. As shown, chamfer 537 is used to convert the vertical force into a force in the x-direction against the removable fixture, while chamfers 539a and 539b are used to convert the vertical force into a force in the y-direction against the fixture. As will be readily understood, only the side edges of chamfer 539a actually make contact with corresponding chamfers on the removable fixture, due to the geometry of the opening 531 therein.

FIG. 6B illustrates in top plan view the exemplary recessed area of the removable fixture shown in FIGS. 5A and 5B according to one embodiment of present invention. Recessed area 535 can located within a raised portion 523 of a bottom plate of the removable fixture in FIG. 5B. This recessed area 535 can include a plurality of chamfered regions 527, 529a, 529b that correspond to the chamfered regions of the corresponding extension 530 shown in FIG. 6B. Again, downward force from the extension delivered to the removable fixture by way of these chamfered regions 527, 529a, 529b results in component lateral forces on the fixture, which moves the fixture in one or two lateral directions that are perpendicular to the primary axis of cylinder 540. Again, various suitable profiles and shapes for chamfered regions may be implemented, as desired. Also, extension 530 can be shaped and dimensioned such that it fits through opening 531 when it is in a first or open position, and such that its chamfers 537, 539a, 539b engage corresponding chamfers 527, 529a, 529b respectively when it is in a second or clamped position.

Turning lastly to a flowchart of an exemplary method of handing manufacturing items in a CNC system is provided. It will be readily appreciated that the various steps set forth can be implemented as desired, and that some steps may be removed, while others not shown may be added. Furthermore, the order of the various steps may be changed as may be appropriate for a given application, as will he readily appreciated. For example, steps 704 and 702 can be reversed or conducted in parallel, as will be readily appreciated. After a start step 700, a removable fixture is mounted to a receiver base at process step 702. Such a mounting can involve inserting guide pins into guide holes, as described above. At a subsequent process step 704, a cylinder or other elongated member is extended through a central opening in the fixture, after which an extension is coupled to a distal end of the cylinder or elongated component at process step 706. During clamping operation, the cylinder or elongated component (with extension attached) is rotated from a first “open” position to a second “clamping” position at process step 708, and is moved downward against the removable fixture to exert a force thereto at step 710. At step 712, the downward force is translated into lateral force components, which operate to move the removable fixture in those lateral directions. At process step 714, the lateral movement of the removable fixture is stopped, such as per the guide pins contacting various appropriately located datums, as described above. Work items and/or parts are handled on the removable fixture at process step 716. At step 718 the cylinder and extension are rotated back from the second position to thhe first position, and the removable fixture can be removed at step 720. The method then ends at step 722.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A component manufacturing system, comprising:
an elongated component having a longitudinal axis therethrough defining a first direction, said elongated component being adapted both to rotate about and travel along the first direction, and also to deliver a force along the first direction;
an extension coupled to said elongated component, said extension extending outward from said elongated component in a second direction having a component that is perpendicular to the first direction, wherein said extension operates to convert said force from the first direction to second and third directions having components perpendicular to each other and the first direction; and
a removable fixture adapted to receive the force delivered thereto by said extension, said fixture having an inner opening extending therethrough along the first direction adapted to receive and permit movement by said elongated component, wherein said removable fixture is adapted to guide manufacturing operations for other manufacturing components, and wherein said removable fixture is moved and positioned in both of said second and third directions as a result of said force.

2. The component manufacturing system of claim 1, wherein said elongated component is cylindrical.

3. The component manufacturing system of claim 1, wherein said extension is removably coupled to a distal end of said elongated component.

4. The component manufacturing system of claim 1, wherein said removable fixture is positioned in both of said second and third directions within a tolerance of one micron as a result of said force

5. The component manufacturing system of claim 1, wherein said elongated component rotates between a first position that enables said extension to clamp against said removable fixture and a second position that enables said removable fixture to be readily removed from said system without removing said extension from said elongated component.

6. The component manufacturing system of claim 1, further including:
a receiver base adapted to support said removable fixture, wherein said removable fixture is positioned accurately with respect to said receiver base in both of said second and third directions as a result of said force

7. The component manufacturing system of claim 6, wherein said removable fixture includes a plurality of guide holes therein, and further including:
a plurality of guide pins coupled to said receiver base, said plurality of guide pins being positioned on said receiver base such that said removable fixture is mountable to said receiver base by matching said plurality of guide pins with the plurality of guide holes.

8. The component manufacturing system of claim 7, wherein one or more of said plurality of guide pins define a cross-section that is generally cylindrical with the exception of at least one flat side.

9. The component manufacturing system of claim 7, further including:
a plurality of datums located in said plurality of guide holes, wherein said plurality of datums operate to position said removable fixture accurately in both of said second and third directions as a result of said force.

10. The component manufacturing system of claim 9, wherein said plurality of datums operate to position said removable fixture by contacting said plurality of guide pins such that motion of said removable fixture in both of the second and third directions is stopped thereby.

11. The component manufacturing system of claim 1, wherein each of said extension and said removable fixture include a plurality of chamfered regions adapted to engage each other when said extension moves in said first direction against said removable fixture, and wherein said engaging chamfer regions operate to convert said force from the first direction to the second and third directions thereby.

12. A removable CNC fixture comprising:
one or more external surface regions adapted to facilitate the handling of manufacturing parts or work pieces;
a central opening extending therethrough, said central opening being adapted to receive and permit axial and rotational movement therethrough by a separate elongated component having a primary axis and a separate extension coupled thereto;
a plurality of chamfered regions adapted to engage with a plurality of chamfered regions on the extension, wherein an incumbent force from the separate extension causes engagement of the plurality of chamfered regions on the extension onto said plurality of chamfered regions on said removable CNC fixture and results in the movement of said removable CNC fixture ire a plane that is substantially perpendicular to the primary axis of the separate elongated component;
a plurality of guide holes adapted to mount to a plurality of guide pins therethrough from a separate receiver base; and
a plurality of datums located within said plurality of guide holes, wherein said plurality of datums operate to position said removable fixture accurately in said plane as a result of said incumbent force from the separate extension.

13. The removable CNC fixture of claim 12, wherein said removable CNC fixture is positioned in all directions within said plane within a tolerance of one micron as a result of said incumbent force

14. The removable CNC fixture of claim 12, wherein said removable CNC fixture further includes a top plate and a bottom plate mounted together.

15. The removable CNC fixture of claim 12, further including:
a plurality of fixture chamfered regions adapted to engage a plurality of extension chamfered regions on the extension when said extension moves in a direction along said primary axis against said removable fixture, and wherein said engaging chamfer regions operate to convert said incumbent force from a direction along said primary axis to one or more directions perpendicular thereto.

16. The removable CNC fixture of claim 15, wherein said wherein said central opening is shaped such the extension clamps against said removable CNC fixture when the elongated component and extension are at a first rotational position and such that said removable CNC fixture is readily removed from the elongated component and extension without removing the extension from the elongated component when the elongated component and extension are at a second rotational position.

17. A component manufacturing system, comprising:
an elongated component having a longitudinal axis therethrough defining a first direction, said elongated component being adapted both to rotate about and travel along the first direction, and also to deliver a force along the first direction;
an extension coupled to said elongated component, said extension extending outward from said elongated component in a second direction having a component that is perpendicular to the first direction, wherein said extension operates to convert said force from the first direction to second and third directions having components perpendicular to each other and the first direction;
a removable fixture adapted to receive the force delivered thereto by said extension, wherein said removable fixture includes, a plurality of guide holes therein, one or more surface regions adapted to facilitate the handling of manufacturing parts or work pieces, and a central opening extending therethrough along the first direction and adapted to receive and permit movement by said elongated component;
a receiver base adapted to support said removable fixture;
a plurality of guide pins coupled to said receiver base, said plurality of guide pins being positioned on said receiver base such that said removable fixture is mountable to said receiver base by matching said plurality of guide pins with the plurality of guide holes; and
a plurality of datums located in said plurality of guide holes, wherein said plurality of datums operate to position said removable fixture accurately in both of said second and third directions as a result of said force, wherein said removable fixture is moved and positioned in both of said second and third directions as a result of said force.

18. The component manufacturing system of claim 17, wherein said extension is removably coupled to a distal end of said elongated component.

19. The component manufacturing system of claim 17, wherein said elongated component rotates between a first position that enables said extension to clamp against said removable fixture and a second position that enables said removable fixture to be readily removed from said system without removing said extension from said elongated component.

20. The component manufacturing system of claim 17, wherein each of said extension and said removable fixture include a plurality of chamfered regions adapted to engage each other when said extension moves in said first direction against said removable fixture, and wherein said engaging chamfer regions operate to convert said force from the first direction to the second and third directions thereby.

21. A method of handling manufacturing items in a CNC system, comprising:
mounting a removable CNC fixture to a respective receiver base, said mounting step involving the use of a plurality of guide pins on the receiver base and a plurality of corresponding guide holes in the removable CNC fixture;
extending an elongated component having a primary axis through a central opening of said removable CNC fixture, said central opening being adapted to facilitate the axial and rotational movement of said elongated component;
coupling an extension to a distal end of said elongated component while said elongated component is extended through said central opening;
rotating said elongated component about its primary axis such that the position of said extension is altered from a first position to a second position;
moving said elongated component along said primary axis so that said extension contacts and exerts a downward force against said removable CNC fixture;
translating the downward force against said removable CNC fixture into one or more resultant forces having a direction substantially perpendicular to said downward force, wherein said removable CNC fixture moves laterally with respect to said receiver base due to said one or more resultant forces;
stopping said lateral movement of the removable CNC fixture as a result of a plurality of datums located within the guide holes contacting said guide pins, wherein said stopping results in a desired positioning of said removable CNC fixture; and
handling one or more manufacturing items against one or more external surface features of said removable CNC fixture after said stopping step.

22. The method of claim 21, wherein said translating step involves the use of a plurality of chamfered regions on both of said removable fixture and said extension.

23. The method of claim 21, wherein said removable CNC fixture is positioned in at least two directions with respect to said receiver base within a tolerance of one micron as a result of the locations of said datums.

24. The method of claim 21, wherein said elongated component is driven by pneumatic pressure.

25. The method of claim 21, further including:
rotating said elongated component about its primary axis such that the position of said extension is altered from said second position back to said first position; and
removing said removable CNC fixture from CNC system.
